(19) United States
(12) Patent Application Publication
(10) Pub. No.: US 2021/0321169 A1
(43) Pub. Date: Oct. 14, 2021

(54) SMART GLASSES CLOSED CAPTIONING

(71) Applicant: Sony Corporation, Tokyo (JP)

(72) Inventors: Bibhudendu Mohapatra, San Diego, CA (US); David Andrew Young, SR., San Diego, CA (US); Aran London Sadja, San Diego, CA (US); Allison Joi Burgueno, Oceanside, CA (US); Marcus D. Yee, Mountain View, CA (US); Seyed Soheil Banisadr, San Diego, CA (US)

(21) Appl. No.: 16/845,073

(22) Filed: Apr. 10, 2020

(51) Int. Cl. H04N 21/488; H04N 21/485; G10L 15/00; G02B 27/01

(52) U.S. Cl. CPC H04N 21/4884; H04N 21/4856; G02B 2027/0178; G02B 27/0172; G02B 2027/014; G10L 15/005

(57) ABSTRACT

An assembly includes a display configured to present video, a first head mount such as smart glasses wearable on a head of a first user, and a second head mount wearable on a head of a second user. A processor is configured to send closed captioning (CC) in a first language to the first head mount for presentation thereon while the first user is viewing the video on the display, and to send the CC in a second language to the second head mount for presentation thereon while the second user is viewing the video on the display.

### FIELD

The application relates generally to presenting closed captioning on smart glasses.

### BACKGROUND

As understood herein, video content can be available in multiple languages for audio and closed-captioning purposes. However, as also understood herein, viewing typically must be experienced in one audio language and one closed-captioning language based on selections either in the device or in the application, which can be frustrating when a common display is being viewed by people who speak different languages.

### SUMMARY

Accordingly, present principles provide an assembly which includes at least one video display device configured to present video. The assembly further includes at least a first head mount wearable on a head of a first user and at least a second head mount wearable on a head of a second user. The assembly also includes at least one processor configured with instructions executable to send closed captioning (CC) in a first language to a first display on the first head mount for presentation thereon while the first user is viewing the video on the video display device. The instructions also are executable to send the CC in a second language to a second display the second head mount for presentation thereon while the second user is viewing the video on the video display device.

In example embodiments, the instructions may be executable to identify the first language at least in part based on input of an identification of the first language. In other examples the instructions may be executable to identify the first language at least in part based on speech recognition indicating speech in the first language.

In some implementations the at least one processor is in the video display device. In other implementations the at least one processor includes a first processor in the first head mount and a second processor in the second head mount. In such implementations the first processor may be configured with instructions to receive CC in a first language and the second processor may be configured with instructions to receive the CC in the first language, translate the CC to the second language, and present the CC in the second language on the second head mount.

The head mounts may be implemented as smart glasses or an augment reality (AR) head-mounted displays (HMD).

In another aspect, a method includes presenting video on a video display, and presenting text related to the video in a first language on a first at least partially transparent display of a first head mount in line of sight of the video display. The method also includes presenting text related to the video in a second language on a second at least partially transparent display of a second head mount in line of sight of the video display.

In another aspect, an assembly includes at least one video display. The assembly further includes at least a first head mount that in turn includes at least a first display through which video on the video display can be seen. Moreover, the assembly includes at least a second head mount that in turn includes at least a second display through which video on the video display can be seen. The assembly also includes at least one processor configured with instructions that are executable to present text related to the video in a first language on the first display of the first head mount, and present text related to the video in a second language on the second display of the second head mount.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 illustrates an example assembly consistent with present principles;

FIG. 2 illustrates an example smart glasses which may be used to view objects including overlaying objects onto images seen on a display such as a TV;

FIG. 3 is a block diagram of internal components of the smart glasses;

FIGS. 4-7 illustrate in example flow chart format example logic consistent with present principles;

FIG. 8 illustrates an example user interface (UI) consistent with present principles;

FIGS. 9 and 10 illustrate in example flow chart format example logic consistent with present principles;

FIG. 11 illustrates two example smart glasses presenting text in respective languages while viewing a common display; and

FIGS. 12 and 13 illustrate an example smart glasses worn by a user showing variation of CC size.

### DETAILED DESCRIPTION

In overview, a source can send closed captions in language X to one smart glasses display device, language Y to another smart glasses display device and so on. Also, the source can send information about menu items in different languages X, Y, Z to various devices for overlaying. In this way, people who speak different languages can view closed captioning in their language of preference while all may be watching a common video screen. Further, handling menu functionalities is facilitated by presenting each user options in that user's language. Users can change size of closed captioning, menu for their own needs.

In some cases, a video source sends closed captions in different languages to connected smart glasses. The smart glasses overlay the CC on the display as per the user's configuration (language, positioning, font color/size/style). The configuration maybe realized in the source or the sink. A menu can be overlaid in way that makes it readable for the user to enable user to select appropriate menu item.

This disclosure relates generally to computer ecosystems including aspects of consumer electronics (CE) device networks such as but not limited to smart glasses and smart (computerized) vehicles. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/ or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

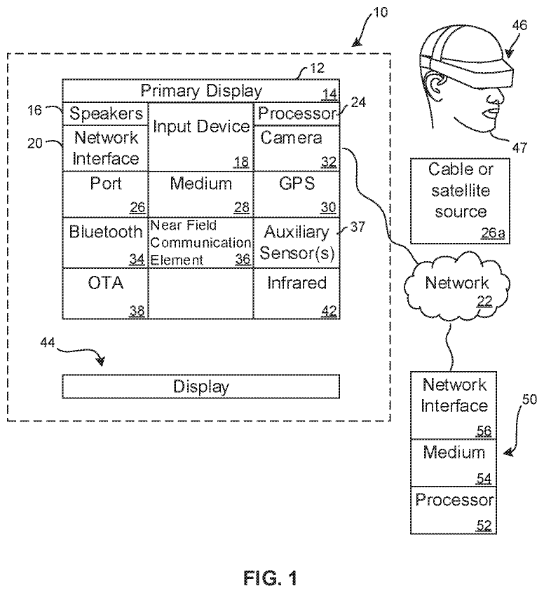

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input ports 26 such as a high definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or, the source 26a may be a game console or disk player containing content. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimensions.

Continuing the description of the AVD 12, in some embodiments the AVD 12 may include one or more cameras 32 that may be a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12.

Still referring to FIG. 1, in addition to the AVD 12, the system 10 may include one or more other CE device types. In one example, a first CE device 44 may be included in or integrated with a vehicle while a second CE device 46 may be implemented as head-mounted viewing device such as smart glasses. All devices in FIG. 1 may communicate with each other. A computerized device herein may implement some or all of the components shown for the AVD 12. Any of the components shown in the following figures may incorporate some or all of the components shown in the case of the AVD 12.

Now in reference to the afore-mentioned at least one server 50, it includes at least one server processor 52, at least one tangible computer readable storage medium 54 such as disk-based or solid state storage, and at least one network interface 56 that, under control of the server processor 52, allows for communication with the other devices of FIG. 1 over the network 22, and indeed may facilitate communication between servers and client devices in accordance with present principles. Note that the network interface 56 may be, e.g., a wired or wireless modem or router, Wi-Fi transceiver, or other appropriate interface such as, e.g., a wireless telephony transceiver.

Accordingly, in some embodiments the server 50 may be an Internet server or an entire server “farm”, and may include and perform “cloud” functions such that the devices of the system 10 may access a “cloud” environment via the server 50 in example embodiments for, e.g., network gaming applications. Or, the server 50 may be implemented by one or more game consoles or other computers in the same room as the other devices shown in FIG. 1 or nearby.

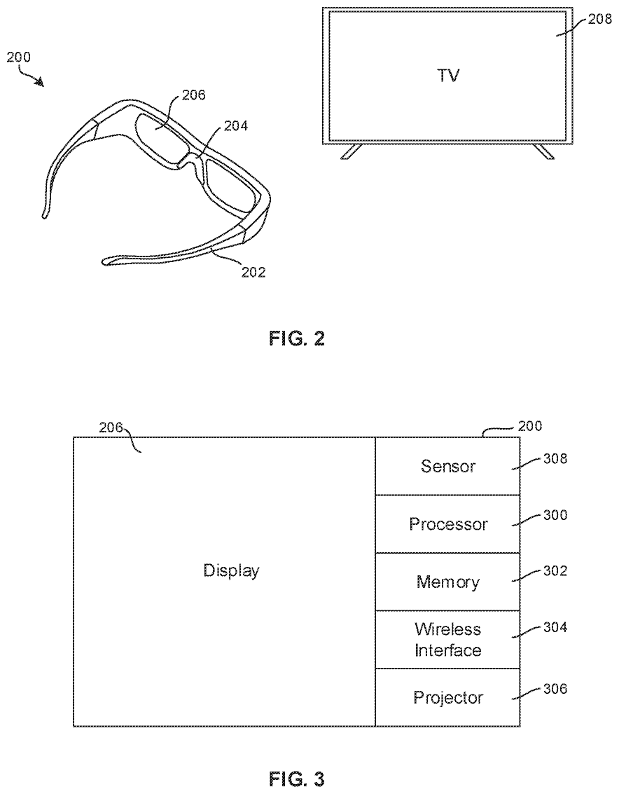

FIG. 2 illustrates a head-worn apparatus 200, in the example shown configured as smart glasses with left and right temples 202, a bridge 204, and left and right see-through displays 206 onto which images may be projected or otherwise established as being overlaid on real world objects seen through the displays 206. A viewer may view images through the displays 206 shown on a video source device such as a video display device such as a TV 208. The head-worn apparatus 200 may be instantiated by contact lens form factors. Yet again, the head-worn apparatus may be implemented as an augmented reality (AR) head-mounted display (HMD) such as but not limited to a Sony Play Station HMD.

FIG. 3 illustrates that the head-worn apparatus 200 may include one or more processors 300 accessing instructions and data on one or more computer memories 302 and communicating with other devices using one or more wireless transceivers 304 such as any of the transceivers described herein. The processor 300 may control one or more projectors 306 to present images on the display(s) 206. The processor 300 may receive input from one or more sensors 308 such as any of the sensors described herein, including cameras (both inward-looking and outward-looking) and microphones.

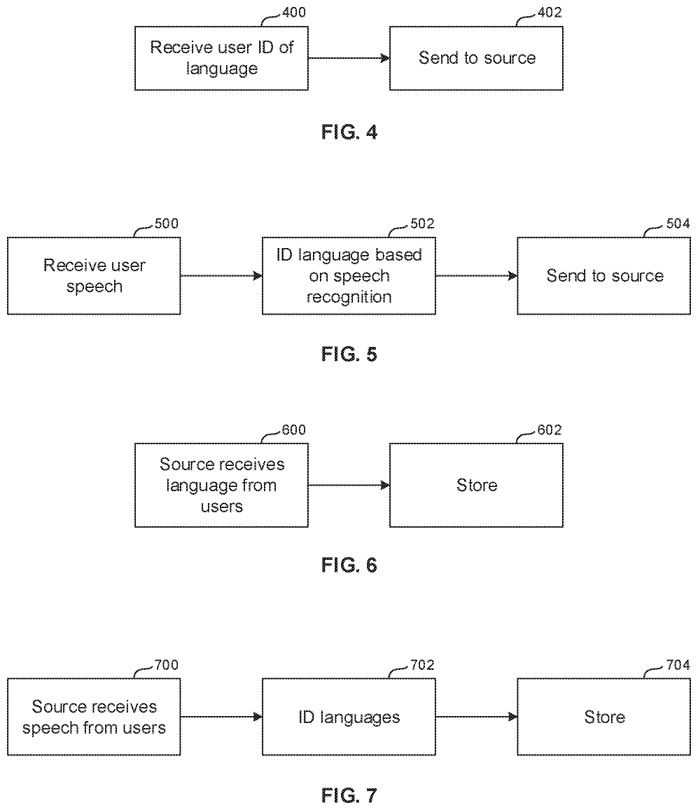

FIG. 4 illustrates that in one embodiment, at block 400 a processor in each of plural head mounts such as the head mount 200 shown in FIGS. 2 and 4 receives, from user input from the wearing user by means of a physical or virtual keypad or other input device, an identification of a language from the respective users The language preferences are stored at block 402 and/or sent to the display device source 208.

FIG. 5 also assumes a head mount-centric implementation in which at block 500 a respective processor in each head mount receives speech from the respective user wearing the head mount. Moving to block 502, using speech recognition, the processor determines what language each user is speaking in. For example, the processor may recognize one stream of phonemes as being in English and a second stream of phonemes to be in Spanish. The languages are stored in the head mounts at block 504 and/or sent to display device source 208.

FIG. 6 illustrates another embodiment in which at block 600 a processor in the video source (e.g., the video display or TV 208 in FIG. 2) receives, from user input by means of a physical or virtual keypad or other input device, an identification of a language from each of plural users. The language preferences are stored at block 602.

FIG. 7 also assumes a display device-centric implementation in which at block 700 a processor in the video source (e.g., the video display or TV 208 in FIG. 2) receives speech from each of plural users viewing the display. Moving to block 702, using speech recognition, the processor determines what language each user is speaking in. For example, the processor may recognize one stream of phonemes as being in English and a second stream of phonemes to be in Spanish. The languages are correlated to the respective users and stored at block 704.

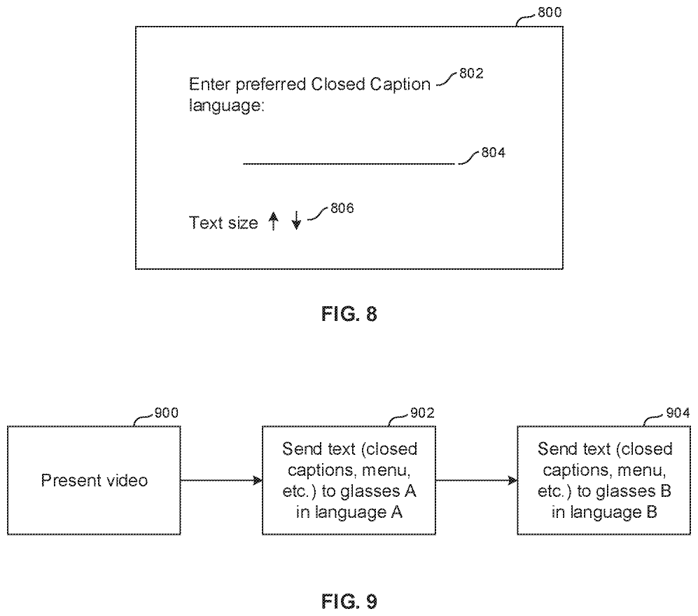

FIG. 8 illustrates a user interface (UI) that may be presented on a display 800 such as any of the displays described herein with a prompt 802 for a user to enter the user's preferred language into a field 804. A selector 806 may be provided by which a user can adjust a size of the font of text to be presented on the user's head-worn apparatus.

FIG. 9 illustrates overall logic for presenting text such as closed captioning (CC) and menu information in different languages on different head-worn apparatus of users viewing the same large video display such as the TV 208 in FIG. 2. Commencing at block 900, video is presented on the source of video display such as the TV 208. Moving to block 902, the processor in the source of video sends to each head-worn apparatus text related to the video in the language of the user of the respective head-worn apparatus as established using any of the techniques described herein. Typically, video from a cable or satellite or broadcast source can include related text in multiple languages, and the display device (e.g., the TV 208) selects, for each head-worn apparatus, text in the language associated with the respective user, sending that text to a first head- worn apparatus in a first language at block 902 and sending the information contained in that same text to a second head-worn apparatus but in a second language at block 904.

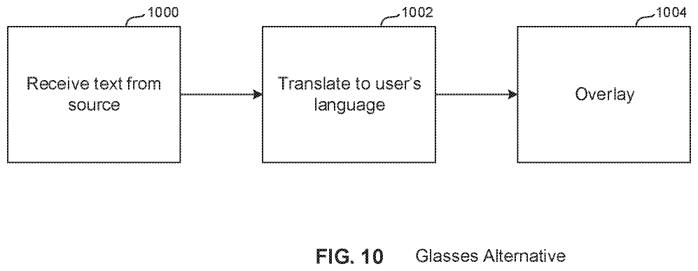

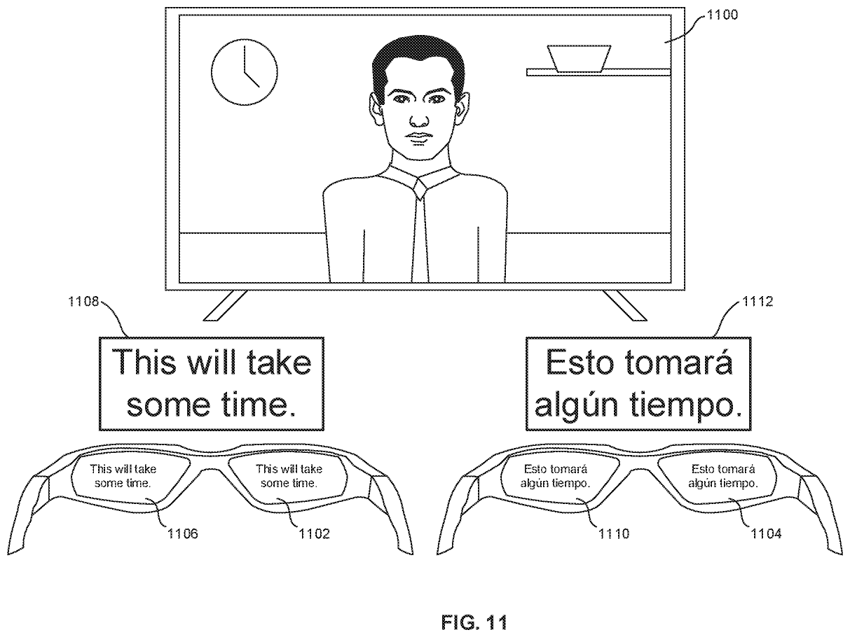

FIG. 10 illustrates an embodiment in which the video display (e.g., the TV 208) presents video as before and sends text related to the video in a single language to each of plural head-worn apparatuses, which is received by each head-worn apparatus at block 1000. If the text is in the respective user's respective language, it may be presented on the head-worn apparatus straightaway at block 1004, but if the text received from the TV 208 is not in the user's preferred language, it is translated by the processor in the head-worn apparatus into the user's preferred language at block 1002 prior to display at block 1004.

FIG. 11 illustrates further. A source 1100 of video, in the example shown embodied as a large screen video display device, can be viewed by first and second users respectively wearing first and second head-worn apparatus 1102, 1104, in the example shown, embodied as smart glasses. Text 1106 related to the video being presented on the source 1100 is presented on the first head-worn apparatus 1102, in the example shown, on each of the left and right see-through display “lenses” of the smart glasses. The non-limiting text is the closed caption phrase “this will take some time” appears to the first user as indicated at 1108 and is presented in English on the first head-worn apparatus 1102.

In contrast, the same CC text 1110 but in a second language (in the example shown, Spanish) is presented on the second head-worn apparatus 1104, in the example shown, on each of the left and right see-through display “lenses” of smart glasses. The text 1110 appears to the second user as indicated at 1112 as “esto tomara algun tiempo”.

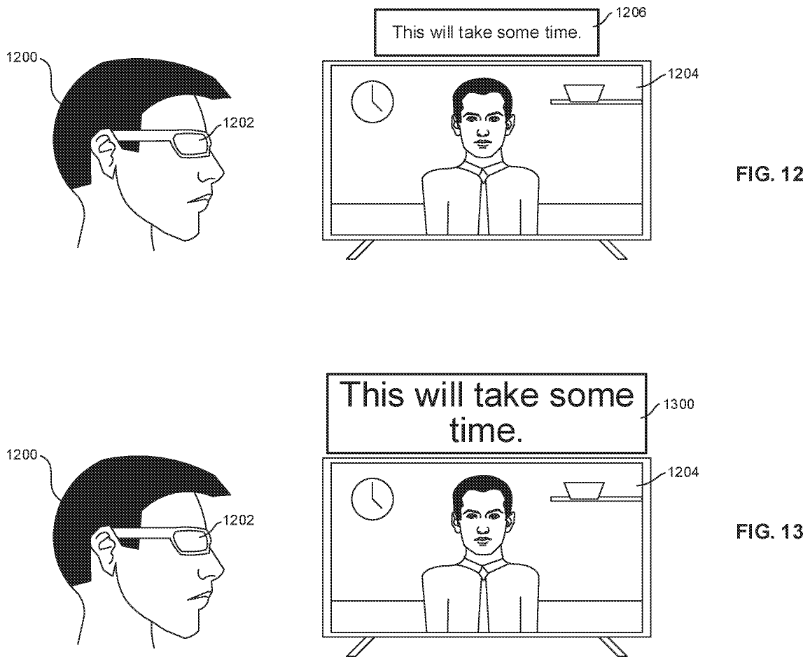

FIG. 12 illustrates an embodiment in which a user 1200 wearing a head-worn apparatus 1202, in the example shown implemented as smart glasses, views video on a display 1204. Text related to the video is presented on the apparatus 1202 and appears to the user as indicated at 1206 in a font with a first size. Using principles herein, the user may change the size of the font so that the text appears in a larger font size as indicated at 1300 in FIG. 13. Text size can be changed using a menu or a gesture in free space such as a pinch motion that is imaged by a camera and processed using machine vision techniques. Likewise, items presented on the smart glasses can be moved using a menu or a gesture in free space such as finger motion.

It will be appreciated that whilst present principals have been described with reference to some example embodiments, these are not intended to be limiting, and that various alternative arrangements may be used to implement the subject matter claimed herein.

1. An assembly comprising:
at least one video display device configured to present video;
at least a first head mount wearable on a head of a first user;
at least a second head mount wearable on a head of a second user; and
at least one processor configured with instructions executable to:
send closed captioning (CC) of the video in a first language to a first display on the first head mount for presentation thereon while the first user is viewing the video on the video display device, the first language being determined using speech recognition to determine what language the first user speaks at least in part by recognizing at least one utterance from the first user to be in the first language; and
send the CC in a second language to a second display the second head mount for presentation thereon while the second user is viewing the video on the video display device, the video being received from a cable or satellite or broadcast source.

2. The assembly of claim 1, wherein the instructions are executable to:
identify the first language at least in part based on input of an identification of the first language.

3. (canceled)

4. The assembly of claim 1, wherein the at least one processor is in the video display device.

5. The assembly of claim 1, wherein the at least one processor comprises a first processor in the first head mount and a second processor in the second head mount.

6. The assembly of claim 5, wherein the first processor is configured with instructions to receive CC in a first language and the second processor is configured with instructions to receive the CC in the first language, translate the CC to the second language, and present the CC in the second language on the second head mount.

7. The assembly of claim 1, wherein the first head mount comprises smart glasses.

8. A method, comprising:
presenting video on a video display;
presenting text related to the video in a first language on a first at least partially transparent display of a first head mount in line of sight of the video display, the first language being determined based at least in part on speech recognition identifying that spoken words are in the first language; and
presenting text related to the video in a second language on a second at least partially transparent display of a second head mount in line of sight of the video display.

9. The method of claim 8, wherein the text comprises closed captioning (CC) from the video.

10. The method of claim 8, wherein the text comprises menu information.

11. The method of claim 8, comprising:
sending signals representing the text in the first language to the first head mount; and
sending signals representing the text in the second language to the second head mount.

12. The method of claim 8, comprising:
sending signals representing the text in the first language to the first head mount and to the second head mount; and
translating the text into the second language at the second head mount.

13. An assembly comprising:
at least one video display;
at least a first head mount comprising at least a first display through which video on the video display can be seen;
at least a second head mount comprising at least a second display through which video on the video display can be seen; and
at least one processor configured with instructions that are executable to:
present to closed captioning text from the video in a first language on the first display of the first head mount; and
present the closed captioning text from the video in a second language on the second display of the second head mount.

14. The assembly of claim 13, wherein the second language is identified based on identifying phonemes of speech being the second language.

15. The assembly of claim 13, wherein the text comprises menu information.

16. The assembly of claim 13, wherein the first head mount comprises smart glasses.

17. The assembly of claim 13, wherein the instructions are executable to:
identify the first language at least in part based on input of an identification of the first language.

18. The assembly of claim 13, wherein the instructions are executable to:
identify the first language at least in part based on speech recognition indicating speech in the first language.

19. The assembly of claim 13, wherein the at least one processor is implemented by the video display.

20. The assembly of claim 13, wherein the at least one processor comprises a first processor in the first head mount and a second processor in the second head mount.
